(19) United States
(12) Patent Application Publication
(10) Pub. No.: US 2021/0316706 A1
(43) Pub. Date: Oct. 14, 2021

(54) BRAKE CONTROL DEVICE

(71) Applicant: ADVICS CO., LTD., Kariya-shi, Aichi-ken (JP)

(72) Inventors: Aritomo NABETA, Obu-shi, Aichi-ken (JP); Masayuki NAITO, Nagakute-shi, Aichi-ken (JP)

(73) Assignee: ADVICS CO., LTD., Kariya-shi, Aichi-ken (JP)

(21) Appl. No.: 17/273,120

(22) PCT Filed: Sep. 26, 2019
(86) PCT No.: PCT/JP2019/038010

§ 371 Date: Mar. 3, 2021

(30) Foreign Application Priority Data
Sep. 28, 2018 (JP) 2018-183174

(51) Int. Cl. B60T 13/68

(52) U.S. Cl. CPC B60T 13/686; F16K 31/06

(57) ABSTRACT

The present disclosure relates to a brake control device that supplies hydraulic pressure from a hydraulic pressure supply source to a wheel cylinder through a hydraulic pressure supply passage, and adjusts braking hydraulic pressure, which is the hydraulic pressure in the wheel cylinder by a solenoid valve provided in the hydraulic pressure supply passage, the brake control device including a control unit that, when holding the solenoid valve in an operating state, applies to the solenoid valve a holding current set to greater than or equal to a minimum required current necessary for holding the solenoid valve in the operating state; and a current adjusting unit that adjusts the holding current based on change in braking conditions.

### TECHNICAL FIELD

The present disclosure relates to a brake control device.

### BACKGROUND ART

A brake control device includes, for example, a hydraulic pressure supply source supplying brake fluid, a solenoid valve provided in a hydraulic circuit connected to the hydraulic pressure supply source, and a control unit controlling the solenoid valve to control the hydraulic pressure of a wheel cylinder, or wheel pressure. The solenoid valve has a solenoid and operates with a control current supplied from the solenoid according to the instruction of the control unit. A normally-open type solenoid valve opening in a non-energization state may need to be continuously supplied with current at or greater than the minimum required current to hold the operating state, or the closed state. The current greater than the minimum required current enable the valve to hold reliably in the operating state, but could cause the valve to overheat.

For example, Japanese Unexamined Patent Application Publication No. 2006-17181 describes a solenoid valve control device that prevents heat generation of the solenoid valve by switching between a control current required at the initial stage of the operation and the minimum required current.

### CITATIONS LIST

### Patent Literature

Patent Literature 1: Japanese Unexamined Patent Application Publication No. 2006-17181

### SUMMARY

### Technical Problems

The minimum required current for holding the operating state is determined by using the pressure difference between the upstream hydraulic pressure in the hydraulic pressure supply passage upstream of the solenoid valve and the downstream hydraulic pressure in hydraulic pressure supply passage downstream of the solenoid valve. The smaller the control current, the less heat of the valve is generated. However, when the control current is smaller than the minimum required current, an unintended release of the operating state occurs. Therefore, objects of this disclosure are an improvement stability of the valve in the operating state and a prevention of heat generation of the valve by determining a suitable control current.

### Solutions to Problems

A brake control device of the present disclosure relates to a brake control device has a hydraulic pressure supply source, a solenoid valve provided in a hydraulic pressure supply passage, a control unit for adjusting a braking hydraulic pressure in the wheel cylinder through the hydraulic pressure supply passage with the hydraulic pressure supply source, and the control unit for supplying the solenoid valve with a holding current to hold the solenoid valve in an operating state, the holding current being greater than or equal to a minimum required current to hold the solenoid valve in the operating state and a current adjusting unit for adjusting the holding current in response to a change in braking conditions.

### ADVANTAGEOUS EFFECTS

As the braking conditions change, the peripheral situations related to the operation of the solenoid valve (e.g., the pressure difference between the upstream and the downstream of the solenoid valve and the probability of a change in the differential pressure) may also change. According to the present disclosure, the holding current is adjusted in consideration of the change in the peripheral situation of the solenoid valve due to the change in the braking conditions. Therefore, a suitable holding current can be determined, such as increasing the holding current in a situation where the pressure difference is likely to change, and bringing the holding current closer to the minimum required current in a situation where the pressure difference is not likely to change. The present disclosure could enable the valve to operate stably while preventing heat generation.

### BRIEF DESCRIPTION OF DRAWINGS

FIG. 1 is a configuration view of a brake control device according to a first embodiment.

FIG. 2 is an explanatory view showing an example of an adjustment of holding current according to the first embodiment.

FIG. 3 is a configuration view showing a configuration of the periphery of a solenoid valve according to a second embodiment.

### DESCRIPTION OF EMBODIMENTS

Hereinafter, embodiments of the present disclosure will be described based on the drawings. Each figure used for the description is a conceptual view, and the shape of each portion is not exact in some cases.

### First Embodiment

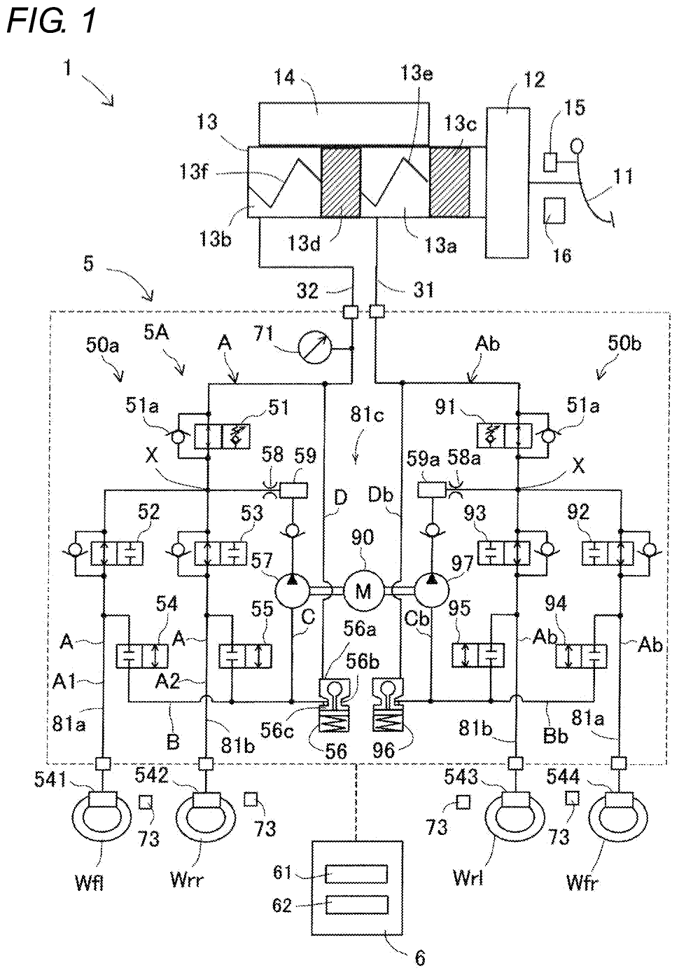

As shown in FIG. 1, a brake control device 1 of the first embodiment includes a brake pedal 11, a booster 12, a master cylinder 13, a reservoir 14, a brake switch 15, a stroke sensor 16, an actuator 5, and a brake ECU 6.

The brake pedal 11 is an operation member that allows the driver to operate the brake. The brake switch 15 is a sensor that detects whether the brake pedal 11 is depressed (whether it is operated). The brake switch 15 is also called a brake stop switch. The brake switch 15 outputs a detection signal to the brake ECU 6. The stroke sensor 16 is a sensor that detects the operation amount (stroke) of the brake pedal 11. The stroke sensor 16 outputs the detection signal to the brake ECU 6.

The booster 12 is, for example, a vacuum booster that assists the brake operation force by utilizing the intake negative pressure from the engine. The master cylinder 13 converts an operation force from the brake pedal 11 by the driver to a master pressure and applies the master pressure to wheel cylinders 541 to 544 through the actuator 5. The master cylinder 13 includes a first master chamber 13a and a second master chamber 13b that generate a master pressure according to the operation of the brake pedal 11. The master cylinder 13 is configured so that the same hydraulic pressure is formed in the first master chamber 13a and the second master chamber 13b. That is, the first master chamber 13a is formed between a first master piston 13c and a second master piston 13d, and the second master chamber 13b is formed between the second master piston 13d and the bottom of the master cylinder 13. A first spring 13e is interposed between the first master piston 13c and the second master piston 13d, and a second spring 13f is interposed between the second master piston 13d and the bottom of the master cylinder 13.

The reservoir 14 is a member that stores the brake fluid and resupplies the brake fluid to the master cylinder 13. In other words, it is a member that stores the brake fluid and is connected to the master chambers 13a and 13b. The master chambers 13a and 13b and the reservoir 14 communicate with each other in the initial state, and are shut off when the strokes of the master pistons 13c and 13d become greater than or equal to a predetermined value. That is, the master pistons 13c and 13d are configured to shut off between the master chambers 13a and 13b and the reservoir 14 when the stroke of the brake pedal 11 is greater than or equal to a predetermined value.

The actuator 5 is arranged between the first master chamber 13a and the second master chamber 13b, where the master pressure is generated, and the wheel cylinders 541, 542, 543 and 544. The actuator 5 and the first master chamber 13a are connected by an oil passage 31, and the actuator 5 and the second master chamber 13b are connected by an oil passage 32. The actuator 5 is a device that adjusts the hydraulic pressure (wheel pressure) of the wheel cylinders 541 to 544 in accordance with an instruction from the brake ECU 6. The actuator 5 executes pressurization control for further pressurizing the brake fluid from the master pressure, pressure reduction control for reducing the wheel pressure, and holding control for holding the wheel pressure in accordance with a command from the brake ECU 6. Furthermore, the actuator 5 can also execute pressure increasing control in which the master pressure is supplied to the wheel cylinders 541 to 544 as is. The actuator 5 executes, for example, anti-lock brake (ABS) control, electronic stability control (ESC), brake assist (BA) control, or the like, based on the command from the brake ECU 6. The wheel pressure corresponds to the braking hydraulic pressure.

The actuator 5 includes a hydraulic circuit 5A and a motor 90. The hydraulic circuit 5A includes a first piping system 50a and a second piping system 50b. The first piping system 50a controls the hydraulic pressure (wheel pressure) to be applied to the front wheel Wfl and the rear wheel Wrr. The second piping system 50b controls the hydraulic pressure (wheel pressure) to be applied to the front wheel Wfr and the rear wheel Wrl. Furthermore, a wheel speed sensor 73 is installed for each wheel W (the symbol of the wheel may be collectively described as “W”).

The first piping system 50a includes a main oil passage A which is a hydraulic pressure supply passage, a pressure difference control valve 51, holding valves 52 and 53, a pressure reducing oil passage B, pressure reducing valves 54 and 55, a pressure adjusting reservoir 56, a reflux oil passage C, a pump 57, an auxiliary oil passage D, an orifice portion 58, a damper portion 59, and a pressure sensor 71. In the description, the term “oil passage” can be replaced with a term such as, for example, a hydraulic pressure path, a flow path, a pipeline, a passage, or a piping.

The main oil passage A is an oil passage connecting the oil passage 32 and the wheel cylinders 541 and 542. That is, the main oil passage A (and the oil passage 32) connects the master cylinder 13 (second master chamber 13b) and the wheel cylinders 541 and 542. The pressure difference control valve 51 is a solenoid valve provided in the main oil passage A to control the main oil passage A to an open state (instructed pressure equals zero) and a pressure difference state (instructed pressure is greater than zero). The pressure difference state can also be said to be the throttle state. The pressure difference control valve 51 controls the pressure difference between the hydraulic pressure in the master cylinder 13 side of itself and the hydraulic pressure in the wheel cylinders 541 and 542 side of itself according to the instructed pressure (control current) from the brake ECU 6. That is, the pressure difference control valve 51 is a solenoid valve capable of adjusting the difference in hydraulic pressure between the hydraulic pressure in the master cylinder 13 and the hydraulic pressure in the wheel cylinders 541 to 544. The pressure difference control valve 51 is a valve capable of controlling the hydraulic pressure in the wheel cylinders 541 to 544 side of itself to higher than the hydraulic pressure on the master chambers 13a and 13b side of itself by the instructed pressure.

The pressure difference control valve 51 is installed with a check valve 51a that allows the brake fluid to flow from the master cylinder 13 side (upstream) to the wheel cylinders 541 to 544 side (downstream) and prohibits the brake fluid from flowing from the wheel cylinders 541 to 544 side to the master cylinder 13 side. Furthermore, the main oil passage A branches into two oil passages A1 and A2 at a branch point X located downstream of the pressure difference control valve 51. The oil passage A1 and A2 corresponds one to one the wheel cylinders 541 and 542.pressure difference

The holding valves 52 and 53 are solenoid valves that open and close according to the instruction from the brake ECU 6, and are normally-open type solenoid valves that open in a non-energization state. The holding valve 52 is disposed in the oil passage A1 and the holding valve 53 is disposed in the oil passage A2. The holding valves 52 and 53 open in a non-energization state during the pressure increasing control to communicate with the wheel cylinders 541 and 542 and the branch point X. In the holding control and the pressure reduction control, the holding valves 52 and 53 close when the holding valves 52 and 53 are supplied with a predetermined control current. This disconnects the wheel cylinders 541 and 542 from the branch point X. The holding valves 52 and 53 are linear valves that can control the hydraulic pressure at the branch point X side (upstream) to be higher than the hydraulic pressure in the wheel cylinders 541 and 542 side (downstream) by the instructed pressure.

The pressure reducing oil passage B is an oil passage that connects between the holding valve 52 and the wheel cylinder 541 in the oil passage A1 and the pressure adjusting reservoir 56, and connects between the holding valve 53 and the wheel cylinder 542 in the oil passage A2 and the pressure adjusting reservoir 56. The pressure reducing valves 54 and 55 are solenoid valves that open and close according to the instruction from the brake ECU 6, and are normally-closed type solenoid valves that are in the closed state (shutoff state) in the non-energization state. The pressure reducing valve 54 is disposed in the pressure reducing oil passage B on the wheel cylinder 541 side. The pressure reducing valve 55 is disposed in the pressure reducing oil passage B on the wheel cylinder 542 side. The pressure reducing valves 54 and 55 are energized to be in the open state mainly at the time of pressure reduction control, and communicate the wheel cylinders 541 and 542 and the pressure adjusting reservoir 56 through the pressure reducing oil passage B. The pressure adjusting reservoir 56 is a reservoir including a cylinder, a piston, and a biasing member.

The reflux oil passage C connects the pressure reducing oil passage B (or pressure adjusting reservoir 56) and between (here, branch point X) the pressure difference control valve 51 and the holding valves 52 and 53 in the main oil passage A. The pump 57 is provided in the reflux oil passage C so that a discharge port is disposed on the branch point X side and an intake port is disposed on the pressure adjusting reservoir 56 side. The motor 90 drives the pump 57, which is an electric pump. The pump 57 discharges the brake fluid to the portion of the main oil passage A through the reflux oil passage C. The portion is the branch point X in the first embodiment, located in the main oil passage between the pressure difference control valve and the wheel cylinders 541 and 542.pressure difference Furthermore, for example, in the open state in the anti-skid control, the pump 57 pumps the brake fluid in the wheel cylinders 541 and 542 back to the master cylinder 13 through the pressure reducing valves 54 and 55. In this way, the pump 57 is disposed between the master cylinder 13 and the wheel cylinders 541 and 542, and can discharge the brake fluid in the wheel cylinders 541 and 542. The orifice portion 58 and the damper portion 59 are pulsation reducing mechanisms.

The auxiliary oil passage D is an oil passage that connects a pressure adjusting hole 56a of the pressure adjusting reservoir 56 and the main oil passage A upstream (or master cylinder 13) of the pressure difference control valve 51 in. A valve hole 56b of the pressure adjusting reservoir 56 closes with increase in the inflow amount of the brake fluid to the pressure adjusting hole 56a due to increase in stroke. A reservoir chamber 56c is located on the oil passages B and C side of the valve hole 56b.

When the pump 57 is driven, the brake fluid in the pressure adjusting reservoir 56 or the master cylinder 13 is discharged to a portion (branch point X) between the pressure difference control valve 51 and the holding valves 52, 53 in the main oil passage A through the reflux oil passage C. The wheel pressure rises according to the control state of the pressure difference control valve 51 and the holding valves 52 and 53. As described above, in the actuator 5, the pressurization control is executed by driving the pump 57 and controlling various valves. The pressure sensor 71 detects the master pressure. The pressure sensor 71 transmits the detection result to the brake ECU 6.

The second piping system 50b has a configuration similar to the first piping system 50a, and includes a main oil passage Ab that corresponds to the main oil passage A and connects the oil passage 31 and the wheel cylinders 543 and 544, a pressure difference control valve 91 that corresponds to the pressure difference control valve 51, holding valves 92 and 93 that correspond to holding valves 52 and 53, a pressure reducing oil passage Bb that corresponds to the pressure reducing oil passage B, pressure reducing valves 94 and 95 that correspond to the pressure reducing valves 54 and 55, a pressure adjusting reservoir 96 that corresponds to the pressure adjusting reservoir 56, a reflux oil passage Cb that corresponds to the reflux oil passage C, a pump 97 that corresponds to the pump 57, an auxiliary oil passage Db that corresponds to the auxiliary oil passage D, an orifice portion 58a that corresponds to the orifice portion 58 and a damper portion 59a that corresponds to the damper portion 59. As the explanation of the first piping system 50a can be referred to for the detailed configuration of the second piping system 50b, the description thereof will be omitted.

The following explains briefly each control state by driving the brake ECU 6 by taking the control on the wheel cylinder 541 as an example. In pressure increasing control state, the pressure difference control valve 51 and the holding valve 52 open, the pressure reducing valve 54 closes, and the master pressure is applied to the wheel cylinder 541. In the pressure reduction control, the holding valve 52 closes and the pressure reducing valve 54 opens. In the holding control, the holding valve 52 and the pressure reducing valve 54 close. In another holding control, the holding valve 52 opens, the pressure reducing valve 54 closes, the pressure difference control valve 51 throttles. In the pressurization control, the pressure difference control valve 51 is in the pressure difference state (throttle state), the holding valve 52 opens, the pressure reducing valve 54 closes, and the pump 57 is driven.

The brake ECU 6 has a CPU, a memory, and the like. Various sensors such as the brake switch 15, the stroke sensor 16, the pressure sensor 71, and the wheel speed sensor 73 are connected to the brake ECU 6 by a communication line (not shown). The brake ECU 6 determines whether the actuator 5 needs to be operated based on the detection results of these various sensors. When determining that the actuator 5 needs to be operated, the brake ECU 6 calculates a target wheel pressure, which is a target value of the wheel pressure for each wheel cylinder 541 to 544, and controls the actuator 5. The target wheel pressure corresponds to the target hydraulic pressure braking force (target deceleration) is determined based on the brake operation or automatic brake control.

The brake ECU 6 can determine the master pressure, which is upstream pressure, with the detected value of the pressure sensor 71, and calculate the hydraulic pressure in the wheel cylinders 541, 542, which is downstream pressure, based on the detected value of the pressure sensor 71 and the control states of the pressure difference control valve 51, the holding valves 52, 53 and the pressure reducing valves 54, 55. The calculation of the hydraulic pressure of the wheel cylinders 543 and 544 in the second piping system 50b can be done using the above method.

### (Summary of the Configuration of the First Embodiment Excluding the Brake ECU)

As described above, the brake control device 1 in the first embodiment includes the master cylinder 13 and the pumps 57 ,97, and the holding valves 52, 53, 92, 93 provided in the main oil passages A, Ab connected to the hydraulic pressure supply source. The brake control device 1 controls the holding valves 52, 53, 92, 93 to adjust the wheel pressure applied to the wheel W. In other words, the brake control device 1 applies the hydraulic pressure to the wheel cylinders 541 to 544 through the main oil passages A and Ab with the hydraulic pressure supply source. The holding valves 52, 53, 92, 93 adjust the wheel pressure (braking hydraulic pressure), which is the hydraulic pressure in the wheel cylinders 541 to 544. The holding valves 52, 53, 92, 93 are solenoid valves that open in the non-energization state, provided to hold the hydraulic pressure in the hydraulic pressure supply passage downstream of the holding valves 52, 53, 92, 93 in the main oil passages A and Ab at the hydraulic pressure of less than or equal to the hydraulic pressure in the hydraulic pressure supply passage upstream of the holding valves 52, 53, 92, 93. The holding valve, such as the pressure difference control valves 51 and 91, may hold the hydraulic pressure in the hydraulic pressure supply passage downstream of the holding valve greater than or equal to the hydraulic pressure in upstream the pressure difference control valves 51 and 91.

### (Holding Current Adjustment)

The brake ECU 6 controls the state of each solenoid valve by supplying a control current. The brake ECU 6 has a control unit 61 and a current adjusting unit 62 for holding the operating state of the holding valves 52, 53, 92, 93. The following describes holding valve 52, and the description of the other holding valves 53, 92, and 93 will be omitted as they are the same as those of the holding valve 52.

The control unit 61 supplies, to the holding valve 52, a holding current set to greater than or equal to the minimum required current required to hold the holding valve 52 in the operating state. The operating state of the holding valve 52 means a state in which the holding valve 52 closes. The holding current is supplied to hold the holding valve 52 in the closed state. The minimum required current is determined on the basis of the operating characteristic estimated for a solenoid valve. Thus, the minimum required current is determined on the basis of the relationship between the pressure difference between the hydraulic pressure in the hydraulic pressure supply passage upstream of the solenoid valve and the hydraulic pressure in the hydraulic pressure supply passage downstream of the solenoid valve and the minimum current value required to hold the closed state of the solenoid valve at such a pressure difference. That is, the minimum required current changes depending on the pressure difference. The holding valve 52 has an operating characteristic in which the minimum required current increases as the pressure difference increases.

Holding the holding valve 52 in the operating state, the control unit 61 determines the minimum required current according to an estimated value (or actual value) of the pressure difference (hereinafter referred to as “upstream-downstream pressure difference”) between the hydraulic pressure in the upstream and the hydraulic pressure in downstream of the holding valve 52 in the main oil passage A. Then, the control unit 61 determines a value of a holding current by adding the value of the minimum required current to the value of an additional current. The minimum required current plus the additional current equals the holding current. The additional current is greater than or equal to zero. The additional current may be a constant value or a value that changes according to the upstream-downstream pressure difference.

The current adjusting unit 62 adjusts the holding current based on the change in the braking conditions. The current adjusting unit 62 in the first embodiment adjusts the additional current based on the change in the braking conditions. The current adjusting unit 62 adjusts the additional current higher (and thus the holding current) as a probability of an increase in the upstream-downstream pressure difference is higher. In other words, the current adjusting unit 62 adjusts the additional current lower(and thus the holding current) as the probability of the increase in the upstream-downstream pressure difference is lower.

In detail, the high or low of the probability of the increase in the upstream-downstream pressure difference can be determined by using the following viewpoints. The current adjusting unit 62 determines the level of the probability based on the presence or absence of the brake operation by the driver. When the brake switch 15 or the stroke sensor 16 detects the brake operation is being performed, for example, the current adjusting unit 62 determines that the probability is high compared to a case in which the brake operation is not performed. When the brake operation is performed, the master pressure (upstream pressure) tends to increase, and the upstream-downstream pressure difference also tends to increase.

Furthermore, the current adjusting unit 62 determines the high or low of the probability based on the operating state of the pressure reducing valve 54. When determining that the pressure reducing valve 54 is open or an instruction to open the pressure reducing valve 54 is issued from the control status (control current) grasped by the brake ECU 6, the current adjusting unit 62 determines that the above probability is high compared to a case in which the pressure reducing valve 54 is closed. When the pressure reducing valve 54 is opened, the wheel pressure (downstream pressure) tends to reduce and the upstream-downstream pressure difference tends to increase.

Furthermore, the current adjusting unit 62 determines the high or low of the probability based on the state of the pressure adjusting reservoir 56. The current adjusting unit 62 estimates the amount (storage amount) of the brake fluid stored in the pressure adjusting reservoir 56 based on the control status and the control history determined by the brake ECU 6. The storage amount of the brake fluid in the pressure adjusting reservoir 56 can be estimated from, for example, the operating status (control flow rate) of the pressure reducing valves 54 and 55, the driving status (control flow rate) of the pump 57, and the like.

When the storage amount of the brake fluid in the pressure adjusting reservoir 56 is close to the maximum capacity (e.g., when the estimated brake fluid amount is greater than or equal to a first threshold value), the current adjusting unit 62 determines that the above probability is high. As the storage amount of the brake fluid increases, the upstream pressure tends to increase easily due to pumping by the pump 57, and the upstream-downstream pressure difference tends to increase.

The current adjusting unit 62 determines the level of probability based on the above three determination results. The current adjusting unit 62 sets a higher level as the probability becomes higher, for example, by increasing the level according to the number of determinations determined to have a high probability among the three determination results (e.g., zero the level three). The current adjusting unit 62 increases the additional current as the level becomes higher. That is, the current adjusting unit 62 adjusts the holding current according to the change in the braking conditions based on the above determination results regardless of fluctuation in the upstream-downstream pressure difference.

Furthermore, the current adjusting unit 62 increases the additional current (and thus the holding current) as the degree of influence on the adjustment of the wheel pressure due to the inability to hold the operating state of the holding valve 52 increases. In other words, the current adjusting unit 62 reduces the additional current (and thus the holding current) as the degree of influence on the adjustment of the wheel pressure due to the inability to hold the operating state decreases. That is, the current adjusting unit 62 adjusts the additional current in consideration of the degree of influence on the adjustment of the wheel pressure due to the inability to hold the operating state of the holding valve 52.

In detail, the current adjusting unit 62 determines that the degree of influence is larger, as a storage amount of the brake fluid in the pressure adjusting reservoir 56 is larger when the pressure reducing valve 54 is in the open state. For example, the current adjusting unit 62 determines that the degree of influence is large when the pressure reducing valve 54 is in the open state and the storage amount of the brake fluid in the pressure adjusting reservoir 56 is greater than or equal to the first threshold value. Similar to the above, the current adjusting unit 62 estimates the storage amount of the brake fluid in the pressure adjusting reservoir 56 based on the control status, the control history, and the like. The determination of each determination element (storage amount, etc.), probability, or magnitude in the degree of influence may be estimated by dividing into three or more categories according to a plurality of threshold values (large, medium, small, etc.).

The storage limit value (maximum capacity) is more easily reached as the storage amount of the brake fluid in the pressure adjusting reservoir 56 is larger. When the storage amount of the brake fluid in the pressure adjusting reservoir 56 reaches the storage limit value, the brake fluid cannot flow into the pressure adjusting reservoir 56 and thus the pressure cannot be reduced when attempting to reduce the wheel pressure by opening the pressure reducing valve 54. It can be said that such situation is more likely to occur as the storage amount of the brake fluid in the pressure adjusting reservoir 56 is larger.

Here, when the pressure reducing valve 54 is in the open state, it means that the pressure reduction control is being executed, but if the holding valve 52 is transiently opened at this time, the brake fluid flows into the pressure adjusting reservoir 56 through the holding valve 52 and the pressure reducing valve 54. This transient inflow of the brake fluid increases the storage amount of the brake fluid in the pressure adjusting reservoir 56. Therefore, the larger the storage amount, the easier the storage amount reaches the storage limit value due to the unintended opening of the holding valve 52, and the larger the influence on the pressure reduction control. The current adjusting unit 62 adjusts the additional current higher as the degree of influence is higher.

The current adjusting unit 62 increases the additional current and thus the holding current based on the highness of probability and the magnitude of the degree of influence. For example, the current adjusting unit 62 can further change the adjustment amount of the additional current according to the “degree of influence” even within the same level with respect to the level corresponding to the above probability. For example, the current adjusting unit 62 sets level zero when the number of determinations determined as “high probability” among the three determination results is zero, level one when such a number is one, level two when such a number is two, and level three when such a number is three. Then, the current adjusting unit 62 further selects, for example, level zero or level zero plus, level one or level one plus, level two or level two plus, level three or level three plus according to the magnitude of the degree of influence at the set level. This makes it possible to set eight types of adjustment values, which can range from zero to three plus. The degree of influence may be divided into three or more, such as large, medium, and small (e.g., levels zero minus, zero, zero plus).

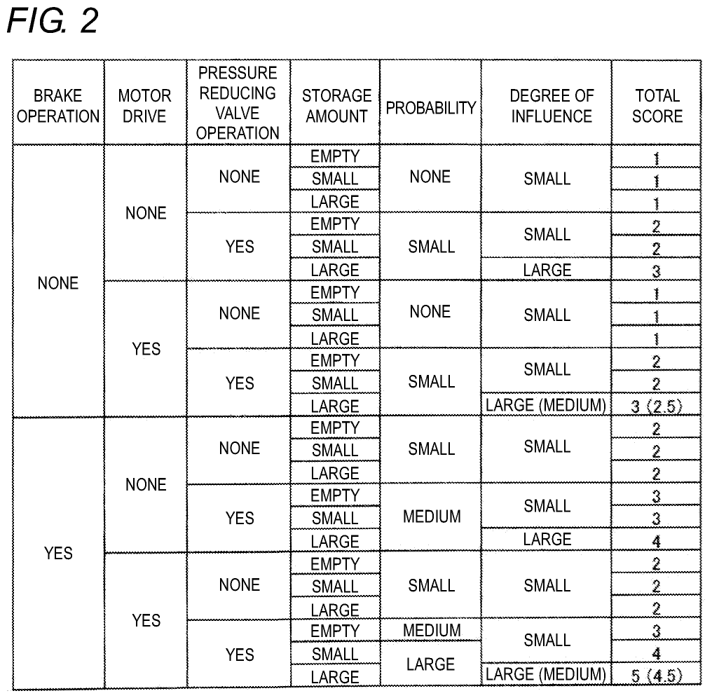

In further detail, an example of the adjustment of the current adjusting unit 62 will be described with reference to FIG. 2. Unlike the above, the current adjusting unit 62 determines the additional current based on the idea of score addition. The additional current becomes larger as the score becomes larger. The additional current is added to the minimum required current corresponding to the estimated upstream-downstream pressure difference. The displayed score of the current amount of the holding current is for comparison purposes. The same scores may be set to different current values. Furthermore, the drive of the motor 90 and the drive of the pump 57 correspond to each other.

### (First Case)

The first case is a case where there is no brake operation and the pressure reducing valve 54 is not operated. In the first case, the above probability is determined to be “none”, and the probability score is zero point, regardless of whether the motor 90 is driven and the storage amount of the brake fluid in the pressure adjusting reservoir 56 (empty, small, large). Furthermore, in the first case, the pressure reducing valve 54 is not operated, thus the degree of influence is determined to be “small”, and the score of the degree of influence is one point. Therefore, in this case, the current value corresponding to a total of one point is set as the additional current.

### (Second Case)

The second case is a case where there is no brake operation and the pressure reducing valve 54 is operated. In the second case, the above probability is determined to be “small”, and the probability score is one point, regardless of whether the motor 90 is driven and the storage amount of the brake fluid in the pressure adjusting reservoir 56. Furthermore, regarding the degree of influence, when the storage amount of the brake fluid in the pressure adjusting reservoir 56 is “empty” or “small”, the possibility that the storage amount of the brake fluid in the pressure adjusting reservoir 56 will reach the storage limit value is small, the degree of influence is determined to be “small”, and the score of the degree of influence is one point. On the other hand, when the storage amount of the brake fluid in the pressure adjusting reservoir 56 is “large”, the degree of influence is determined to be “large”, and the score of the degree of influence is two points. That is, in the second case, the current value corresponding to a total of two points is set as the additional current when the storage amount of the brake fluid in the pressure adjusting reservoir 56 is “empty” or “small”, and the current value corresponding to a total of three points is set as the additional current when the storage amount is “large”.

As another control in the second case, when there is no brake operation, the pressure reducing valve 54 is operated, the motor 90 is driven, and the storage amount of the brake fluid in the pressure adjusting reservoir 56 is “large”, the storage amount of the brake fluid in the reservoir 56 may reduce by the drive of the motor 90, and the degree of influence may be determined to be “medium”. In this case, the score of the degree of influence may be, for example, 1.5 points, the total may be 2.5 points, and the current value between the two points and three points may be set as the additional current.

### (Third Case)

The third case is a case where there is brake operation and the pressure reducing valve 54 is not operated. In the third case, the above probability is determined to be “small”, and the probability score is one point, regardless of whether the motor 90 is driven and the storage amount of the brake fluid in the pressure adjusting reservoir 56. Furthermore, in this case, the pressure reducing valve 54 is not operated, and thus the degree of influence is determined to be “small”, and the score of the degree of influence is one point. In this case, the additional current is the current value corresponding to a total of two points.

### (Fourth Case)

The fourth case is a case where there is brake operation, the pressure reducing valve 54 is operated, and the motor 90 is not driven. In the fourth case, the above probability is determined to be “medium”, and the probability score is two points according to the brake operation and the operating state of the pressure reducing valve 54 regardless of the storage amount of the brake fluid in the pressure adjusting reservoir 56. The degree of influence is determined to be “small” when the storage amount of the brake fluid in the pressure adjusting reservoir 56 is “empty” or “small”, and the score of the degree of influence is one point. On the other hand, when the storage amount of the brake fluid in the pressure adjusting reservoir 56 is “large”, the degree of influence is determined to be “large”, and the score of the degree of influence is two points. That is, in the fourth case, the total is four points when the storage amount of the brake fluid in the pressure adjusting reservoir 56 is “large”, and the total is three points in other cases.

### (Fifth Case)

The fifth case is a case where there is brake operation, the pressure reducing valve 54 is operated, and the motor 90 is driven. In the fifth case, when the storage amount of the brake fluid in the pressure adjusting reservoir 56 is “empty”, the increase in the upstream pressure by the motor 90 can be ignored, and thus the above probability is determined to be “medium”, and the probability score is two points, as in the fourth case. On the other hand, when the storage amount of the brake fluid in the pressure adjusting reservoir 56 is “small” or “large”, the above probability is determined to be “large” and the probability score is three points, in consideration of the influence of the increase in the upstream pressure with the motor 90.

The degree of influence is determined to be “small” and the score is one point when the storage amount of the brake fluid in the pressure adjusting reservoir 56 is “empty” or “small”, and is determined to be “large” and the score is two points when the storage amount of the brake fluid in the pressure adjusting reservoir 56 is “large”. In other words, in the fifth case, when the storage amount of the brake fluid in the pressure adjusting reservoir 56 is “empty”, the total is three points (The probability score is two points. The degree of influence score is one point). Furthermore, when the storage amount of the brake fluid in the pressure adjusting reservoir 56 is “small”, the total is four points (The probability score is three points. The degree of influence score is one point). Moreover, when the storage amount of the brake fluid in the pressure adjusting reservoir 56 is “large”, the total is five points (The probability score is three points. The degree of influence score is two points).

As another control in the fifth case, when there is brake operation, the pressure reducing valve 54 is operated, the motor 90 is driven, and the storage amount of the brake fluid in the pressure adjusting reservoir 56 is “large”, the storage amount of the brake fluid in the reservoir 56 may reduce by driving the motor 90, and the degree of influence may be determined to be “medium”. In this case, the score of the degree of influence may be, for example, 1.5 points, and the total may be 4.5 points.

Upon holding the operating state of the holding valve 52, the control unit 61 adds the additional current determined by the current adjusting unit 62 according to the braking conditions to the minimum required current determined based on the estimated upstream-downstream pressure difference, and applies the same to the holding valve 52 as the holding current. In the first embodiment, the additional current is varied according to the braking conditions, and the minimum required current is varied according to the upstream-downstream pressure difference.

### (Effect)

As described above, as the braking conditions change, the peripheral situations related to the operation of the solenoid valve may also change. (e.g., the pressure difference between the upstream and the downstream of the solenoid valve and the probability of the pressure difference will change.) According to the present disclosure, the holding current is adjusted in consideration of the change in the peripheral situation of the solenoid valve due to the change in the braking conditions. Therefore, as described above, a suitable holding current can be determined, such as increasing the holding current in a situation where the pressure difference is likely to change, and bringing the holding current closer to the minimum required current in a situation where the pressure difference is not likely to change. The stability of the operating state can be improved while preventing heat generation by variably controlling the holding current (additional current) according to the situation so that the holding current does not become insufficient.

Furthermore, more stable brake control can be executed by determining the holding current in consideration of the degree of influence on the adjustment of the braking hydraulic pressure when the operating state is unintentionally released. The current adjusting unit 62 changes the holding current (additional current) according to the change in the braking conditions even when there is no change in the estimated or actually measured upstream-downstream pressure difference, that is, even when the upstream-downstream pressure difference is constant. Thus, the stability of the operating state and the stability of the brake control can be more reliably maintained.

### Second Embodiment

Unlike the first embodiment, the current adjusting unit 62 in the second embodiment adjusts the holding current applied the normally-closed type solenoid valve (linear valve) that closes in the non-energization state. In the description of the second embodiment, the description and the drawings of the first embodiment can be referred to.

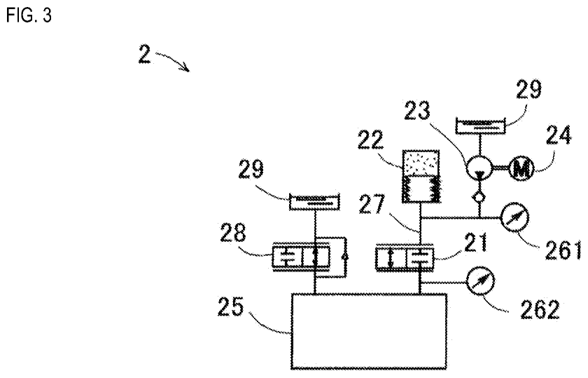

As shown in FIG. 3, a booster 2 in the second embodiment includes a solenoid valve 21 to be adjusted for the holding current, an accumulator 22 which is a high-pressure source, a pump 23 that pressurizes the brake fluid in the accumulator 22, a motor 24 that drives the pump 23, a servo chamber 25 provided at the rear end of a master cylinder 13, a pressure sensor 261 that detects the hydraulic pressure, or accumulator pressure, in the accumulator 22, a pressure sensor 262 that detects the hydraulic pressure, the servo pressure, in the servo chamber, a hydraulic pressure supply passage 27, a pressure reducing valve 28, and a reservoir 29. The master pistons 13c and 13d are driven according to the servo pressure. That is, the servo pressure corresponds to the master pressure.

The solenoid valve 21 is provided in the hydraulic pressure supply passage 27 that connects the accumulator 22, which is the hydraulic pressure supply source, to the servo chamber 25, which is the hydraulic pressure supply destination. The solenoid valve 21 is a normally-closed solenoid valve. The solenoid valve 21 opens in the operating state. An operating characteristic of the solenoid valve 21 is that the minimum required current decreases as the pressure difference between the upstream and the downstream increases. A regulator may be disposed between the solenoid valve 21 and the servo chamber 25. Furthermore, the hydraulic pressure supply destination may be the wheel cylinders 541 to 544.

The control unit 61 opens the solenoid valve 21 and closes the pressure reducing valve 28 to increase the servo pressure. Furthermore, the control unit 61 closes the solenoid valve 21 and opens the pressure reducing valve 28 to reduce the servo pressures. Moreover, the control unit 61 closes the solenoid valve 21 and the pressure reducing valve 28 to hold the servo pressure. Holding the solenoid valve 21 in the operating state, or the open state, the control unit 61 supplies the holding current through the solenoid valve 21. The value of the holding current is the sum of the minimum required current and the additional current.

The current adjusting unit 62 determines the additional current (the holding current) in consideration of the probability of the pressure difference reduction between the upstream and the downstream and the degree of influence on the adjustment of the braking hydraulic pressure (the wheel pressure) due to the unintentional closing of the valve like the first embodiment. The current adjusting unit 62 determines that the probability is high as, for example, the possibility of reduction in the accumulator pressure increases. Then, the current adjusting unit 62 may increase the additional current. When the operating state continues for longer than or equal to a predetermined period of time in a case where the accumulator pressure is in the hydraulic pressure range where the pump 23 stops (the hydraulic pressure region greater than or equal to a set lower limit value and less than or equal to a set upper limit value), the current adjusting unit 62 may determine that the probability is high.

Furthermore, the current adjusting unit 62 determines that the degree of influence is larger as the pressure increasing gradient of the target servo pressure is larger, or the difference between the wheel pressure and the target wheel pressure is larger. Then, the current adjusting unit 62 increases the additional current. The larger the target pressure increasing gradient, the more urgently the wheel pressure needs to be increased because of maintaining responsiveness. It is considered that the influence of the transient closing of the solenoid valve 21 is relatively large. Effects of the second embodiment is the same as those of the first embodiment.

### Others

The present disclosure is not limited to the embodiments described above. For example, in the first embodiment, the control unit 61 and the current adjusting unit 62 may increase the holding current as the increase amount of the upstream-downstream pressure difference over time in the operating state increases. That is, the control unit 61 and the current adjusting unit 62 estimate or detect the increase amount (increasing gradient) of the upstream-downstream pressure difference over time even while the holding current is being applied, and increase the minimum required current or the additional current based on the operating characteristics according to the increase of the upstream-downstream pressure difference. The control unit 61 and the current adjusting unit 62 change the holding current once set according to the braking conditions while holding the operating state. Effects similar to the present embodiment are also exhibited. However, a more suitable holding current can be determined by considering the probability and the degree of influence described above.

Furthermore, the probability determination by the current adjusting unit 62 may be made by using one or two of the above three determination elements (whether there is brake operation, whether the pressure reducing valve 54 is operated, and the magnitude of the storage amount of the brake fluid in the pressure adjusting reservoir 56), or other determination elements may be used. Furthermore, as for the determination on the degree of influence, a determination element other than the above can be used. Moreover, the present disclosure can be applied to the techniques of automatic driving and automatic brake.

1. A brake control device, comprising:
a hydraulic pressure supply source;
a solenoid valve provided in a hydraulic pressure supply passage;
a control unit configured to adjust a braking hydraulic pressure in the wheel cylinder through the hydraulic pressure supply passage with the hydraulic pressure supply source, and the control unit configured to supply the solenoid valve with a holding current to hold the solenoid valve in an operating state, the holding current being greater than or equal to a minimum required current to hold the solenoid valve in the operating state; and
a current adjusting unit configured to adjust the holding current in response to a change in braking conditions.

2. The brake control device according to claim 1, wherein
the solenoid valve is a holding valve opening in a non-energization state, and the solenoid valve is configured to hold a downstream hydraulic pressure in the hydraulic pressure supply passage downstream of the solenoid valve against an upstream hydraulic pressure in the hydraulic pressure supply passage upstream of the solenoid valve, and
the current adjusting unit is configured to adjust the holding current higher as a probability of an increase in a pressure difference between the downstream hydraulic pressure and the upstream hydraulic pressure is higher.

3. The brake control device according to claim 1, wherein
the solenoid valve is a holding valve opening in a non-energization state, and the solenoid valve is configured to hold a downstream hydraulic pressure in the hydraulic pressure supply passage downstream of the solenoid valve against a upstream hydraulic pressure in the hydraulic pressure supply passage upstream of the solenoid valve, and
the current adjusting unit is configured to adjust the holding current higher as a degree of influence on an adjustment of the braking hydraulic pressure due to inability to hold the operating state is larger.

4. The brake control device according to claim 1, wherein
the solenoid valve is a holding valve opening in a non-energization state, and the solenoid valve is configured to hold a downstream hydraulic pressure in the hydraulic pressure supply passage downstream of the solenoid valve against an upstream hydraulic pressure in the hydraulic pressure supply passage upstream of the solenoid valve, and
the current adjusting unit is configured to adjust the holding current higher as an increase rate of a pressure difference between the downstream hydraulic pressure and the upstream hydraulic pressure in the operating state is higher.

5. The brake control device according to claim 2, wherein
the solenoid valve is a holding valve opening in a non-energization state, and the solenoid valve is configured to hold a downstream hydraulic pressure in the hydraulic pressure supply passage downstream of the solenoid valve against a upstream hydraulic pressure in the hydraulic pressure supply passage upstream of the solenoid valve, and
the current adjusting unit is configured to adjust the holding current higher as a degree of influence on an adjustment of the braking hydraulic pressure due to inability to hold the operating state is larger.

6. The brake control device according to claim 4, wherein
the solenoid valve is a holding valve opening in a non-energization state, and the solenoid valve is configured to hold a downstream hydraulic pressure in the hydraulic pressure supply passage downstream of the solenoid valve against a upstream hydraulic pressure in the hydraulic pressure supply passage upstream of the solenoid valve, and
the current adjusting unit is configured to adjust the holding current higher as a degree of influence on an adjustment of the braking hydraulic pressure due to inability to hold the operating state is larger.
